(19) United States
(12) Patent Application Publication
(10) Pub. No.: US 2004/0184463 A1
(43) Pub. Date: Sep. 23, 2004

(54) Transmission of packets as a function of their total processing time

(75) Inventors: Philippe Dauchy, Paris (FR); Alberto Conte, Paris (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/773,322

(22) Filed: Feb. 9, 2004

(30) Foreign Application Priority Data
Mar. 21, 2003 (FR) 03 03 467

(51) Int. Cl. H04J 3/16; H04L 12/56

(52) U.S. Cl. 370/395.21; 370/468

(57) ABSTRACT

A method of transmitting a packet within a telecommunication network, wherein a total processing time is associated with the packet and modified by at least some network equipments as a function of a particular processing time and the network equipments process the packet as a function of the associated total processing time.

### CROSS-REFERENCE TO RELATED APPLICATIONS

This application is based on French Patent Application No. 03 03 467 filed Mar. 21, 2003, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to the transmission of pockets within a data network, especially a telecommunication network. It applies particularly well to the situation where the packets convey data streams necessitating a particular quality of service (QoS).

2. Description of the Prior Art

Assigning to packets that transport data streams with an associated quality of service an identifier value representative of that quality of service is known in the art. The mechanism is that described in RFC 2475 “An Architecture for Differentiated Services”, for example, commonly known as “DiffServ”.

In this prior art solution, the network equipments process packets in accordance with priorities associated with each identifier value (or “color” as it is otherwise known). It is therefore possible to assign a higher priority to data streams necessitating a high quality of service and a lower priority to data streams necessitating a lower quality of service.

This prior art solution has a number of drawbacks, however. In particular, it is unable to arbitrate problems arising from data streams having exactly the same priority, i.e. packets conveying data streams associated with the some class of service.

This is because, for two packets having exactly the same priority, the transmission delay can differ significantly, as a function of the path of taken, i.e. the length of the path (expressed as the number of equipments passed through), and the congestion on that path. In other words, the quality of service actually supplied may vary greatly between two data streams that have requested the same quality of service.

FIG. 1 shows a situation of this kind.

A network N comprises five network equipments R₁ to R₅. The figure shows two data streams: the first enters at R₁ and leaves at R₄. The second enters at R₅ and leaves at R₆. The two data streams have exactly the same priority.

The packets are subjected to standard processing in each network equipment, typically consisting in reading and analyzing a portion of the packet (its header), and then inserting it into an output queue, before transmitting it to the next network equipment. The queue can be longer or shorter, depending on the number of packets passing through the equipment, and thus the time spent in a queue by a packet con also be longer or shorter.

To clarify the explanation, it is assumed hereinafter that the load on a network equipment is a direct function of the length of its queue(s). In other words, the impact of other delays inherent to processing in the equipment concerned is neglected. That impact will have no influence on the statement of the problems associated with the prior art technique or on the validity of the solution according to the invention.

To clarify the explanation, it is assumed in the FIG. 1 example that the various network equipments have substantially identical loads. In this case, it is clear that the packets taking the path R₁, R₂, R₃, R₄ are subjected to a longer delay than those taking the path R₅, R₄, since it passes through a greater number of network equipments.

As the two data streams have exactly the same priority, the network equipment R₄ processes them without differentiating them. As a general rule, the choice to transmit outside of the network N a packet coming from R₅ or R₁ is effected at random.

Consequently, at the output of the equipment R₅, the two data streams have been subjected to very different transmission delays and have different real qualities of service.

Solutions to this problem have been proposed.

For example, patent application EP1193921 (Harris Corp.) makes the processing of packets in a network equipment dependent on a time to live (TTL) field whose value is set by the original sender of the packet and decremented by one unit at each network equipment. However, this solution suffers from the fact that the TTL field measures a distance expressed as a number of network equipments passed through, and not a transmission time: thus no account can be taken of the fact that a particularly heavily loaded network equipment slows the transmission of packets passing through it. Thus this solution does not in fact solve the problem.

The patent application EP0693839 (Toshiba) associates a transmission limit date with the packets and calculates, at each network equipment passed through, whether the packet can reach its destination before the limit date or not. This solution is no more satisfactory, as even though it determines that there is a problem (i.e. that the pocket will not arrive by the intended date), it cannot prevent or anticipate the problem.

The object of the invention is to alleviate the deficiencies of the solutions proposed until now. To this end, the invention makes the scheduling of the packets to be transmitted in a network equipment dependent on the delay already suffered by the packets along the path.

### SUMMARY OF THE INVENTION

To this end, the invention consists in a method of transmitting a packet within a telecommunication network, wherein a total processing time is associated with the packet and modified by at least some network equipments as a function of a particular processing time and the network equipments process the packet as a function of the associated total processing time.

In one embodiment the total processing time is contained in a field of the packet.

In one embodiment the particular processing time is determined by the network equipment as a function of the size of the queue(s) of the network equipment.

For example, the total processing time is initialized, preferably by the sender of the packet, to a maximum transmission time and the particular processing time is subtracted from the total processing time.

The invention also provides a network equipment of a data network, in particular a telecommunication network, having means for receiving incoming packets, means for sending outgoing packets, means for evaluating a basic processing time of incoming packets, means for modifying a value representative of the total processing time contained in the incoming packets, as a function of the basic processing time, and means for choosing outgoing packets in accordance with a priority depending on the total processing time.

In one embodiment the total processing time is contained in a field of the packet.

In one embodiment the particular processing time is determined by the network equipment as a function of the size of the queue(s) of the network equipment.

For example, the total processing time is initialized, preferably by the sender of the packet, to a maximum transmission time and the particular processing time is subtracted from the total processing time.

Thus the packets that have already been delayed the most are given preference by the subsequent equipment(s). In this way the total transmission delay of the packets tends to become harmonized, and the qualities of service actually offered by the network tend to be substantially the same, if the requested qualities of service are themselves identical.

The invention and its advantages will become more clearly apparent in the following description of embodiments of the invention, which description is given with reference to the appended drawings.

### BRIEF DESCRIPTION OF THE DRAWINGS

FIG. 1, already commented on, shows a data network and the problems of a prior art solution.

FIG. 2 is a diagram showing the route of a pocket along a path made up of a plurality of network equipments.

FIG. 3 shows the internal functional architecture of a router type network equipment.

FIG. 4 shows an example of the use of the invention in the FIG. 1 network.

### DETAILED DESCRIPTION OF THE PREFERRED EMBODIMENT

In one embodiment of the invention, the packets contain a total processing time, which can be inserted into one of the fields of the Internet Protocol (IP) header of the packets.

In a preferred embodiment, the value of the total processing time is initialized to a maximum transmission time by the sender of the packets. The sender can be an application level entity that, knowing the semantic content of the packets, is in a position to determine the maximum transmission time, i.e. the required maximum time to transmit the packets end-to-end (i.e. from the sender to the addressee(s)).

At least some of the network equipments through which the packets pass deduct their own processing time from the total processing time. If the total processing time reaches a particular threshold, for example 0, action can be instigated by the network equipment.

In particular, a packet can be eliminated. This is because, if the packet belongs to a video data stream for an on-demand video service, for example, the “real time” factor is of prime importance in obtaining good reproduction at the destination terminal. Thus a packet that is excessively delayed on transmission loses its pertinence, and it may be preferable to lose the packet (and therefore potentially to degrade the video image quality slightly) than to process a packet that has been delayed to much.

Alternatively, the packet can be “upgraded”, i.e. assigned a higher priority, in order to “catch up”.

This mechanism of forcing the loss of a packet if the total processing time falls below a threshold is similar to that used for the time to live (TTL) field specified by the Internet Protocol. However, the TTL field is insufficient to solve the problem addressed by the invention since it measures only the number of network equipments passed through and takes no account of the particular processing time in each network equipment. The particular processing times can be very different, depending on the load on the network equipments.

FIG. 2 shows a path made up of three network equipments A, B and C. A packet P takes this path and includes a field containing the total processing time associated with the packet.

When the network equipment A receives the pocket P, it evaluates its own processing time, i.e. the time that it will take to process the packet itself. That time is a function of its load, and possibly its processing capacity (microprocessor speed, length of queues, etc.), and so on.

It modifies the field of the packet P containing the total processing time as a function of the particular processing time it has evaluated.

The modified packet P_{(A)} is then sent to the network equipment B which, in the same manner, modifies the packet P_{(A)} as a function of its own particular processing time, to form a packet P_{(B)}.

The packet P_{(B)} is finally sent to the network equipment C which in turn modifies it in accordance with its own particular processing time and sends it in the form of a further modified packet P_{(C)}.

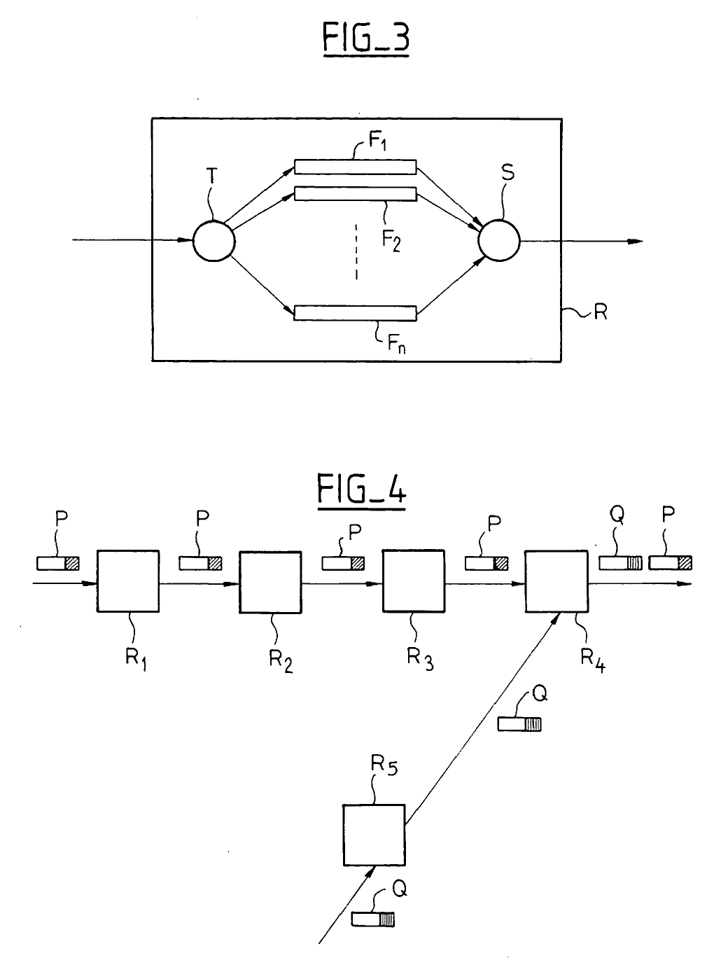

FIG. 3 shows diagrammatically the internal functional architecture of an IP router R made up of a process T, a set of queues F₁ to Fₙ (which can be reduced to a single queue), and a scheduler S.

The incoming packets reach the process T which reads at least a portion of their content, typically the IP header, and chooses, as a function of that content, among other things, to assign the incoming packets to one of the queues F₁ to Fₙ. The choice can be based on a priority indication or a “DiffServ color”, for example.

According to the invention, the process T is further responsible for determining the particular processing time and modifying the total processing time associated with the packet as a function of that particular processing time.

In one embodiment of the invention the particular time is contained in one of the fields of the packet, in particular the IP header. The field can be the “IP options” field, for example, in the case of an implementation under IPv4.

Thus the process T reads the value of the total processing time of the incoming packet.

It also determines the particular processing time, i.e. an estimate of the time that the network equipment R will need to process the packet.

The particular processing time can be a function of the load on the network equipment and in particular, in one embodiment of the invention, on the length of the queues.

To be more precise, the process T can determine the length of the queue Fᵢ in which it inserts the incoming packet. As a function of the length and the average processing time of a packet, it can easily determine the time that the packet will spend in the queue. Given that the time of processing by the process T and by the scheduler S can be considered negligible compared to the time spent in the queue, it is pertinent to consider that the particular time is a function only of the time spent in the queue.

In this embodiment, the particular processing time t(R) of the network equipment R can therefore be defined by the equation:

t(R)=\overline{t_{R}}×L_{R,i}

in which \overline{t_{R}} is the average processing time of a packet by the network equipment R and L_{R,i} is the length of queue number i of the network equipment R, expressed as a number of packets.

The process T can then modify the total processing time as a function of the particular processing time t(R). As previously explained, there are numerous ways to do this.

The packet modified in this way is then inserted into one of the queues F₁ to Fₙ.

In one embodiment of the invention, insertion into one of the queues can be effected as a function of the total processing time.

In a first example, the queues are associated with time intervals corresponding to total processing times. Thus, for example, the queue F₁ corresponds to the total processing time in the range [0; 10 ms], the queue F₂ to the total processing time in the range [11 ms; 20 ms], and so on.

In a second example the queues are associated with priorities in a manner that is conventional in itself. Each incoming packet has a priority. As a function of its total processing time, an incoming packet can be put in a queue other than the one associated with its priority: if a packet has priority 2 but its total processing time is too long, it can be put into the queue F₁ associated with priority 1.

The role of the scheduler is to choose from the queues a packet to be passed to the output port(s). The choice can be made as a function of an order imparted to the set of queues. For example, it can give priority to choosing packets from queue F₁, then queue F₂, then queue F₃, and so on.

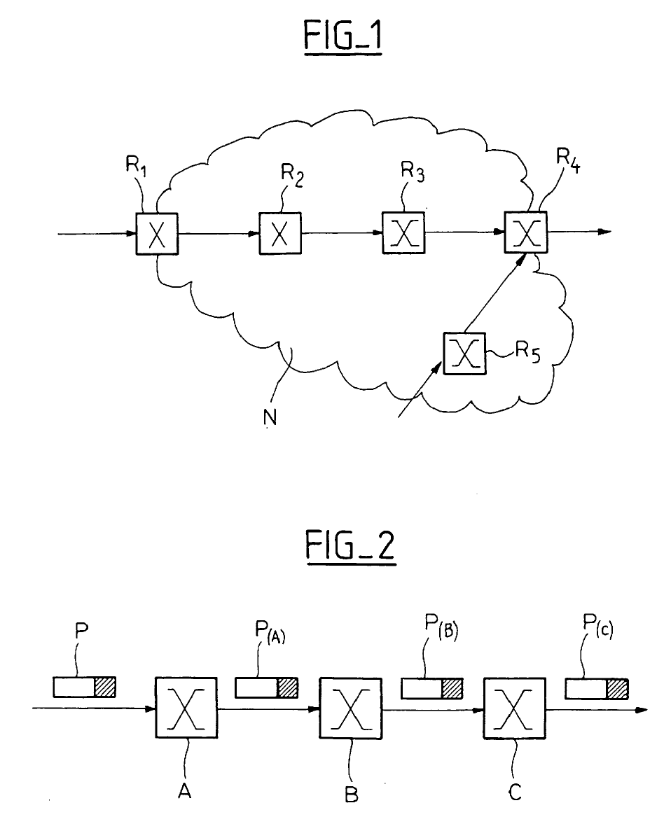

FIG. 3 shows the implementation of the invention in the FIG. 1 network. As in the FIG. 1 example, two data streams are shown, one entering the network via the network equipment R₁ and the other via the network equipment R₅, both leaving via the network equipment R₄. Packets P and Q are considered for each of these data streams.

The total processing time of the two packets is modified along their respective path by the network equipments passed through (for simplicity, the same reference letters P and Q are used all along the path).

Retaining the previous assumption that each network equipment has a similar load, i.e. that the queues of the network equipment are more or less uniformly filled, the total processing time becomes a function of the network equipments passed through.

Consequently, the network equipment R₅ can easily determine that the packet P has been delayed more than the packet Q. It con therefore give preference to choosing the packet P over the packet Q, and thus contribute to reducing the delay.

If this process is repeated over a large number of network equipments, the total processing time can be optimized. If a maximum transmission time has been set, this optimization is naturally effected with reference to that maximum transmission time.

In one embodiment, the value of the total processing time is initially set at 0, and then incremented by the network equipments passed through, by the value of their respective particular processing times.

The value of the total processing time therefore increases, and the network equipments can compare it to a threshold and, as a function of the result of the comparison, trigger mechanisms similar to those described in the context of the preferred embodiment.

Each network equipment is preferably adapted to modify the total processing time and to trigger the appropriate mechanism(s). However, the invention can also operate if only some of the network equipments have the functions described. The invention then functions in “degraded mode”, but will nevertheless represent a substantial improvement over the “standard” prior art mode of operation.

There is claimed:

1. A method of transmitting a pocket within a telecommunication network, wherein a total processing time is associated with said packet and modified by at least some network equipments as a function of a particular processing time and said network equipments process said packet as a function of the associated total processing time.

2. The method claimed in claim 1 wherein said total processing time is contained in a field of said packet.

3. The method claimed in claim 1 wherein said particular processing time is determined by said network equipment as a function of the size of the queue(s) of said network equipment.

4. The method claimed in claim 1 wherein said total processing time is initialized, preferably the sender of said packet, to a maximum transmission time and said particular processing time is subtracted from said total processing time.

5. A network equipment of a data network, in particular a telecommunication network, having means for receiving incoming packets, means for sending outgoing packets, means for evaluating a basic processing time of incoming packets, means for modifying a value representative of the total processing time contained in said incoming packets, as a function of said basic processing time, and means for choosing outgoing packets in accordance with a priority depending on said total processing time.

6. The network equipment claimed in claim 5 wherein said total processing time is contained in a field of said packet.

7. The network equipment claimed in claim 5 wherein said particular processing time is determined by said network equipment as a function of the size of the queue(s) of said network equipment.

8. The network equipment claimed in claim 5 wherein said total processing time is initialized, preferably by the sender of said packet, to a maximum transmission time and said particular processing time is subtracted from said total processing time.
